(19) United States
(12) Patent Application Publication
(10) Pub. No.: US 2025/0170759 A1
(43) Pub. Date: May 29, 2025

(54) Device for Providing a Plastic, and Method for Metering Out the Plastic

(71) Applicant: Henkel AG & Co. KGaA, Düsseldorf (DE)

(72) Inventors: Mario Metzler, Götzis (AT); Guenter Baldauf, Hohenweiler (AT); Daniela Stancheva-Schwind, Frastanz (AT); Pascal Schneider, Möggers (AT)

(21) Appl. No.: 19/036,223

(22) Filed: Jan. 24, 2025

Related U.S. Application Data
(63) Continuation of application No. PCT/EP2023/069877, filed on Jul. 18, 2023.

(30) Foreign Application Priority Data
Jul. 26, 2022 (EP) 22186880.5

(51) Int. Cl. B29B 7/60; B29B 7/72; B29B 7/80; B29B 7/88

(52) U.S. Cl. CPC B29B 7/60; B29B 7/72; B29B 7/801; B29B 7/88

(57) ABSTRACT

The invention relates to a device (1) and method for providing a plastic (2) which is formed from an A component (3) and a B component (4) and optionally from a first additive (6), wherein the device (1) has a mixing chamber (70), in which the A component (3) and the B component (4) are mixed in order to form the plastic (2) and from which the plastic (2) is metered out, and has an additional valve unit (30), which is fluidically connected upstream of an A inlet (71) of the mixing chamber (70) for the A component (3), wherein the additional valve unit (30) has a main pipe (31) for feeding the A component (3) to the A inlet (71) and has a first additional injection valve (33) for feeding the first additive (6) into the main pipe (31), wherein the first additional injection valve (33) has an outlet nozzle (36) opening into the main pipe (31), wherein a nozzle tip (37) of the outlet nozzle (36) lies in a central region of the flow cross section of the main pipe (31), wherein the points of the flow cross section that lie on an inner section of a radial connecting line between a cross section center and an inner wall of the main pipe (31) fall in the central region, wherein the length of the inner section has a value of 90% of the radial connecting line.

The invention relates to a device for providing a plastics which can be produced from an A component and a B component and optionally a first additive. The invention also relates to a method for metering out the plastics.

DE 20 2005 020 930 U1 discloses a device in which polyol is used as component A and isocyanate as component B for the production of polyurethane. The device has a container in which polyol is stored. In addition, the device has a first source for the first additive in the form of a first dye. In addition, the device additionally has a second source for a second additive (second dye). In a mixing chamber, the polyol component and the isocyanate component are mixed to form the polyurethane. The polyurethane is metered out of this mixing chamber and sprayed onto a substrate to be coated to form a polyurethane surface.

An additional valve unit or color valve unit is connected upstream of an A inlet or polyol inlet of the mixing chamber in terms of flow. Upstream, there is a premixing chamber for each individual dye in which the polyol is mixed with the dye. Each premixing chamber is assigned a pump that pumps the correspondingly colored polyol into the additional valve unit via a color-specific supply line. In addition, a circulation line and a circulation valve are provided for each color to direct unused material back into the corresponding premixing chamber. A line leads from the additional valve unit to the polyol inlet of the mixing chamber. The device thus makes it possible to provide a plastics with different properties, namely in this case in different colors. The structure of the device disclosed in DE 20 2005 020 930 U1 is comparatively complex.

US 2007/0145641 A1 discloses a device for providing colored polyurethane, in which feed lines from a polyol source, from an isocyanate source and from two further sources open into the mixing chamber, which feed lines store, on the one hand, a mixture of polyol and a blowing agent and, on the other hand, a mixture of polyol and a dye. Due to there being several inlets, the mixing chamber has a complex structure. In addition, only a colored polyol can be introduced into the mixing chamber, or it is expected to be very time-consuming to remove the previous dye from the device before using another dye.

The object of the invention is therefore to provide a device for providing a plastics which has a simple structure and can be operated without a great amount of effort, even if the properties of the plastics are changed.

The object addressed by the invention is achieved by the combination of features according to claim 1. Embodiments of the invention can be found in the dependent claims of claim 1.

According to the invention, the additional valve unit has a main pipe for feeding the A component to the A inlet and a first additional injection valve for feeding the first additive into the main pipe. The first additional injection valve has an outlet nozzle opening into the main pipe, wherein a nozzle tip of the outlet nozzle lies in a central region of the flow cross section of the main pipe. The central region of the flow cross section includes all points of the flow cross section that lie on an inner portion of a radial connecting line between a cross section center and an inner wall of the main pipe, wherein the length of the inner portion is 90% of the radial connecting line.

In one embodiment, the flow cross section of the main pipe is circular, wherein the radial connecting line corresponds to a radius R of the circle. According to the invention, the nozzle tip of the outlet nozzle is to be located in a central circle whose radius Rₘ corresponds to 90% of the radius R. All points within the middle circle thus form the central region of the flow cross section in this embodiment.

The inner diameter of the round main pipe may be from 4 to 10 mm. For an inner diameter of, for example, 6 mm, the radius R is halved, i.e., 3 mm. The radius Rₘ would then be 2.7 mm. According to the invention, the nozzle tip is then located within the middle circle with the radius Rₘ=2.7 mm.

The flow cross section of the main pipe can also be oval or polygonal, for example rectangular. The cross section center of a rectangular flow cross section lies at the intersection of the diagonals of the rectangular flow cross section. The central region in which the nozzle tip of the outlet nozzle is to be located is delimited by a central rectangle of which the cross section center coincides with the cross section center of the flow cross section. The edge length of the middle rectangle is 90% of the edge length of the rectangular flow cross section.

Due to the arrangement according to the invention of the nozzle tip of the outlet nozzle of the first additional injection valve in the middle region of the flow cross section, it is possible for the first additive to be introduced into the main stream of the A component flowing through the main pipe and to be accordingly carried along with the A component. Contact between the first additive and the inner wall of the main pipe can thus be prevented. This has the advantage that the first additive cannot settle on the inner wall of the main pipe, which may lead to carryover if the plastics is no longer intended to contain the first additive and is thus intended to change its properties. For example, the first additive can be a first dye with which the otherwise white plastics is to be colored.

The A component thus represents a coating for the first additive, which prevents or at least drastically reduces direct contact between the additive and the inner wall of the main pipe. This has the advantage that stopping the additive quickly leads to a plastics with modified properties. The new plastics, i.e., the plastics without the previously used additive, does not contain any, or is only contaminated to a small extent by, the previously used additive during a transition phase. If the additive is a color, color streaks in the new plastics, i.e., in the now white or transparent plastics, only appear for a short time and to a small extent.

The length of the inner portion of the connecting line running in the plane of the flow cross section between the cross section center and the inner wall of the main pipe can be 70% or only 50% of the length of the radial connecting line. In the embodiment comprising a circular flow cross section, the radius Rm of the inner circle (inner region) would accordingly be 70% (or 50%) of the radius R of the flow cross section.

In one embodiment, the main pipe is straight, at least it is straight in the region where the color injection valves open into the main pipe. Preferably, the main pipe runs substantially vertically so that the A component can flow through the main pipe from top to bottom. In one embodiment, the main pipe runs exactly vertically.

In order to make the additional valve unit compact, a center axis of the first additional injection valve can be arranged substantially perpendicularly to a center axis of the main pipe. For a vertical main pipe, this would mean that the center axis extends in a horizontal plane.

The additional valve unit may comprise a plurality of additional injection valves, for example four to ten additional injection valves. In one embodiment, seven additional injection valves are provided. Accordingly, the additional valve unit can have at least a second additional injection valve which serves to feed a second additive. If the additives are each dyes, the device according to the invention can be used to produce a different-colored plastic. The additive or additives can also be catalysts, etc.

A center axis of the second additional injection valve and also center axes of further additional injection valves can run substantially perpendicularly to the center axis of the main pipe. In one embodiment, the center axes of all additional injection valves are perpendicular to the center axis of the main pipe.

The first additional injection valve and the second additional injection valve can be arranged one behind the other when viewed in the longitudinal extent of the main pipe. In other words, the additional injection valves can be connected in series when viewed in the direction of flow.

The center axis of the first additional injection valve can be arranged offset from the center axis of the second additional injection valve when viewed in the circumferential direction of the main pipe. This makes it possible to accommodate a plurality of additional injection valves even in a comparatively short main pipe. The arrangement of the additional injection valves can be selected such that all additional injection valves are located only in a circumferential region smaller than 180° (for example only in one quadrant, which would mean an angular region of 90°). This allows for flexible responses to a given limited amount of space.

The first additional injection valve may comprise a needle valve and a gear pump, wherein the center axis of the additional injection valve in this case is to coincide with the center axis of the needle of the needle valve. The needle valve and the gear pump can be housed in a common housing or in separate housings. The needle valve and gear pump are fluidically connected to each other so that a pressure generated by the gear pump is present in the needle valve. The first additional injection valve can also be designed as an eccentric screw pump. The pump and valve components are combined in one design.

The above and the following statements regarding the design and arrangement of the first additional injection valve also apply analogously to the other additional injection valves. Preferably, all additional injection valves used in the additional valve unit have the same structure.

The device may comprise an A metering valve through which the flow of the A component into the mixing chamber is controlled or regulated. The A metering valve can be arranged between the main pipe and the A inlet of the mixing chamber. In one embodiment, the main pipe extends substantially perpendicularly to a center axis of the A metering valve, with the A component entering the A metering valve through a side inlet. The inlet and an outlet of the A metering valve can be substantially perpendicular to each other. This means that within the A metering valve, the A component together with the first additive (or another additive) therein undergoes a change of direction of approximately 90° or exactly 90°. This change in direction can lead to the additive shielded by the A component in the main pipe now coming into contact with the inner wall of the A metering valve and the additive may be able to settle in regions of the A metering valve that are poorly covered by the main flow through the A metering valve. This involves the risk of deposits and corresponding carryover or contamination when changing additives.

In order to avoid the undesirable deposition of one of the additives in the A metering valve as far as possible, the nozzle tip of the first additional injection valve is preferably arranged between the cross section center of the main pipe and an outlet-side longitudinal half of the main pipe. It has been shown that such an arrangement of the nozzle tip improves the transportation of the additive through the A metering valve, especially in the part of the valve in which the 90° change in direction takes place.

A cross section of the outlet nozzle of the first additional injection valve can be circular, oval or teardrop-shaped. The outlet nozzle protruding into the flow cross section represents a flow obstacle for the A component flowing through the main pipe. Due to a flow-optimized cross section of the outlet nozzle with regard to the smallest possible flow resistance for the A component, there are no sharp changes in direction near the color injection site, which would promote mixing of the A component and the first additive. However, good mixing in the main pipe is not desired according to the invention, regardless of the particular design of the cross section of the outlet nozzle. Rather, the first additive should be embedded in the main stream of the A component and contact between the additive and the inner wall of the main pipe should be avoided. Intense mixing of the first additive with the A component (and with the B component) only takes place in the mixing chamber. The mixing chamber can also be a static mixer.

The outlet nozzle can have different shapes. In one embodiment, it is straight and extends coaxially with the center plane of the first additional injection valve. In the embodiment in which the center plane of the first additional injection valve is perpendicular to the center axis of the main pipe, the first additive is injected into the A component perpendicularly to the main flow direction. Alternatively, the outlet nozzle of the first additional injection valve can have an angle of approximately 90° so that the nozzle tip points in the longitudinal direction of the main pipe or in the main flow direction. In this case, the first additive leaves the nozzle tip in the direction of the main flow of the A component. There may also be an inclination angle of between 20 and 70° between the (straight) outlet nozzle and the center axis of the first additional injection valve.

A further object of the invention to provide a method for metering out a plastics is achieved by the combination of features according to claim 13.

Embodiments of the method according to the invention can be found in the claims dependent on claim 13.

According to the invention, the device described here, in particular the device according to any one of claims 1 to 12, is used in the metering-out method, wherein the first additional injection valve is controlled after the first additive has been metered out so that a small portion of the A component is drawn into the outlet nozzle of the first additional injection valve. During the next metering-out process, this drawn-in portion of the A component is then released back into the main pipe.

In one embodiment of the method according to the invention, in which a device with a plurality of additional injection valves is used, the first additional injection valve is arranged upstream of the second additional injection valve when viewed in the flow direction of the main pipe, wherein the first additive formed as a dye is lighter than the second additive formed as a dye. If there are a plurality of additional injection valves, these can be arranged one after the other in the flow direction according to how light the injected additive (dye) is. The additional injection valve comprising the lightest additive then has the greatest distance to the A metering valve. The RGB model can be used to determine the brightness of an additive. The RGB model is an additive color model in which the color becomes brighter the more colors are mixed together.

Between metering out through the first additional injection valve and metering out through the second additional injection valve, the following procedure can be used for rinsing, regardless of whether the additives are dyes: First, metering out through the first additional injection valve is stopped, wherein the A component continues to flow through the main pipe. The first additional injection valve is then controlled in such a way that it draws back some of the first additive and, if necessary, also draws some of the A component out of the main pipe. The first additional injection valve is then closed.

This is followed by metering out through the second additional injection valve. Metering-out of the second additive is started and continued until the concentration of the first additive in the A metering valve is substantially zero (ratio of the first additive to A component, for example, less than 0.1%). The mixing chamber is then rinsed with a cleaning agent, which removes any last color residue of the first additive from the mixing chamber. After rinsing, metering-out of the second color is started again.

The preferred use of the device and method is to provide different-colored polyurethane, wherein the A component is a polyol and the B component is an isocyanate. The viscosity of the polyol can be 50 to 1,000,000 mPas and is preferably in a range between 1,000 and 100,000 mPas. The viscosity of the isocyanate can be 10 to 100,000, preferably 50 to 5,000 mPas. Components A and B can also be other substances, for example silicone, epoxy, MS polymers.

The viscosity of the first additive (and also the other additives) can be 10 to 100,000 mPas. In one embodiment, the viscosities of the first additive and the second additive are each between 200 and 10,000 mPas.

A total discharge quantity at an outlet of the mixing chamber can be 0.2 to 150 g/s, preferably 3 to 30 g/s. The mixing ratio of the A component to the B component can be 10:1 to 1:10. When producing polyurethane, the mixing ratio of polyurethane to isocyanate is preferably between 1:1 and 10:1. The proportion of the additive used in each case in relation to the total discharge quantity can be 0.5 to 20% and preferably 1 to 5%.

It should be noted that two or more additional injection valves can simultaneously meter out their corresponding additive into the main pipe. If the additives are dyes, the plastics is colored by a mixed dye. This makes it possible to provide more than five colors for the plastics in the case of, for example, five additional injection valves.

The invention will be explained in more detail with reference to the embodiments shown in the figures. In the figures:

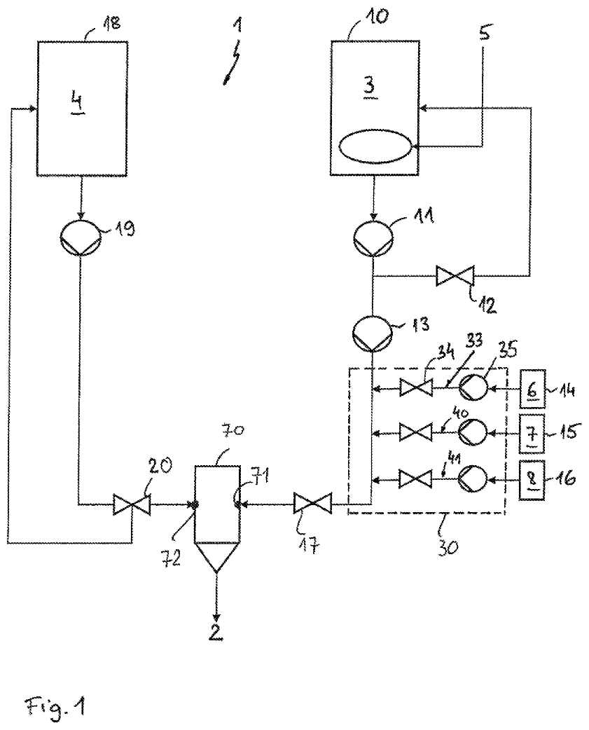

FIG. 1 shows a flow diagram for a device for providing a two-component plastics with different colors;

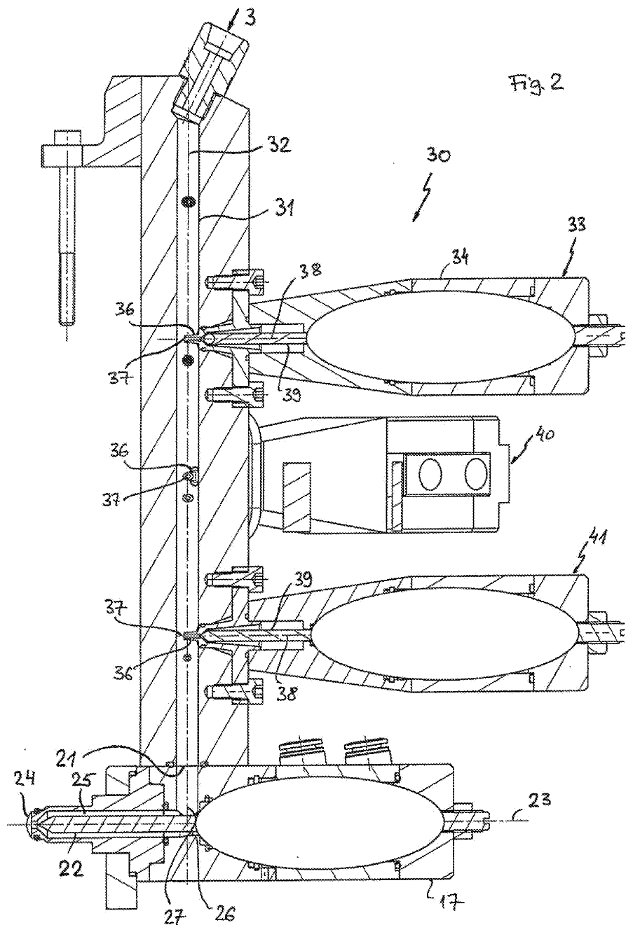

FIG. 2 shows a metering valve for an A component and an additional valve unit;

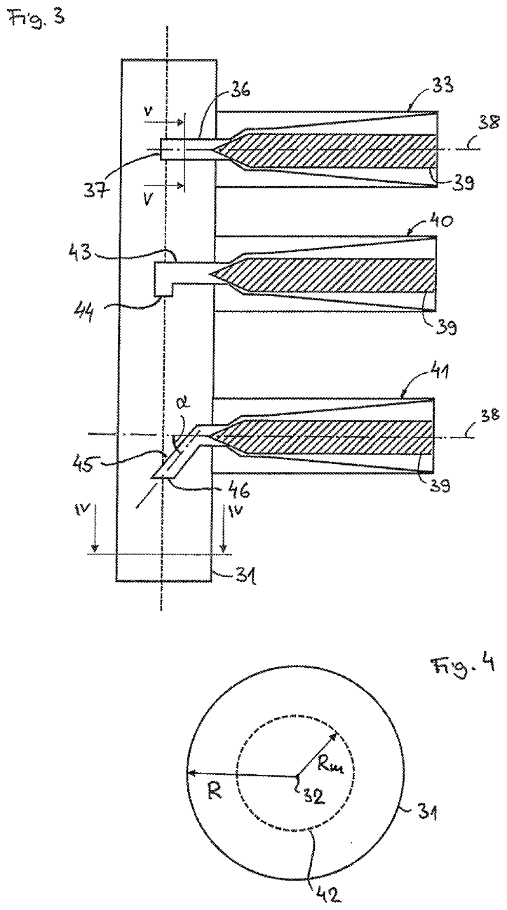

FIG. 3 schematically shows differently outlet nozzles;

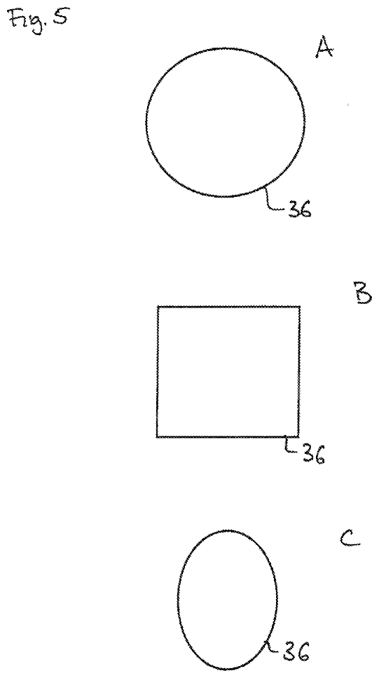

FIG. 4 shows a section along the line IV-IV in FIG. 3; and

FIG. 5 shows a section along the line V-V of FIG. 3 in different embodiments (FIG. 5A, 5B and 5C)

FIG. 1 shows a device which is denoted in its entirety by 1. The device 1 can be used to produce and meter out a plastics 2. The plastics 2 is a multi-component plastics consisting of an A component 3 and a B component 4. In this case, the multi-component plastics is intended to be polyurethane, with the A component being transparent polyol. The B component is isocyanate. Instead of transparent polyol, white polyol can also be used.

The A component or the polyol 3 is stored in an A source 10 designed as a pressure vessel. The pressure vessel 10 is loaded with compressed air 5. The A component 3 is circulated by means of a pre-circulation pump 11. In order to control the pressure of the pre-circulation circuit, a pressure control valve 12 is installed in the circuit. The pre-circulation pump 11 preferably operates continuously at a constant speed.

An A metering pump 13 is supplied with the A component 3 via the pressure of the pre-circulation circuit. The A metering pump 13 delivers the A component to an additional valve unit 30, which is delimited by a dashed rectangle in the illustration in FIG. 1. A first additive 6, a second additive 7 or a third additive 8 is fed to the A component 3 by the additional valve unit 30. Additives 6 to 8 are examples of a plurality of different additives. For example, seven different additives may be provided.

The additives can be different dyes. It is possible for the additional valve unit 30 to add the first additive (dye) 6 and the second additive (dye) 7 to the A component 3 at the same time so that the plastics 2 can also be colored with corresponding mixed colors. The first additive 6 comes from a first additional source 14, which can be, for example, a container. The second additive 7 and the third additive 8 come from a second additional source 15 and from a third additional source 16, respectively. One embodiment of the additional valve unit 30 can be seen in FIG. 2, which will be discussed in more detail later.

Viewed in the flow direction downstream of the additional valve unit 30, a metering valve 17 for the A component 3 (A metering valve 17 for short) is provided, by means of which the mixture of A component 3 and additive is discharged into a mixing chamber 70. The A metering valve 17 is to be arranged immediately upstream of an A inlet 71 of the mixing chamber 70.

The mixing chamber 70 has a further inlet 72 which is provided for the B component 4 (B inlet). The B component 4 comes from a B source 18 (here also designed as a container) and is fed into the mixing chamber 70 via a B metering pump 19 and a B metering valve 20. In the mixing chamber 70, the B component 4 and the A component 3 including one of the additives 6, 7, 8 or including a mixture of the additives 6, 7, 8 are intensely mixed with one another to form the colored multi-component plastics 2. Depending on the additive added to the A component 3 in the additional valve unit 30, the plastics 2 has different properties. Accordingly, a different-colored plastics 2 can be provided by the device 1 if the additives are formed as dyes.

FIG. 2 shows an embodiment of the additional valve unit 30. The additional valve unit 30 comprises a main pipe 31 which has a circular flow cross section. The main pipe 31 opens into a side inlet 21 of the A metering valve 17. The A metering valve 17 is formed as a needle valve with a needle 22 which is arranged so as to be movable along a center axis 23 of the A metering valve 17. The needle 22 allows an outlet 24 of the A metering valve 17 to be closed and opened. The outlet 24 can be connected to the A inlet of the mixing chamber 70 without the need for any intermediate lines or other components (pump, valve, etc.). A center axis 32 of the main pipe 31 and a center axis 27 of the side inlet 21 coincide. The center axis 32 of the main pipe 31 and the center axis 23 of the A metering valve 17 are perpendicular to each other.

The needle 22 is arranged in a cylindrical valve chamber 25 which is fluidically connected to the side inlet 21. Between the needle 22 and the inner wall of valve chamber 25, an annular or hollow-cylindrical cavity is formed through which the A component 3 together with the first additive 6 flows. It has been found that at an inlet-side lower end 26 of the valve chamber 25, opposite the opening of the side inlet 21, the flow through the A metering valve is comparatively weak. Therefore, color residues may mainly collect and deposit at the lower end 26 in the A component 3.

The A component 3 is fed from above into the vertical main pipe 31. The A component 3 flows through the main pipe 31 and reaches the A metering valve 17 via the inlet 21. The volume flow of the A component 3 through the outlet 24 into the mixing chamber 70 can be controlled via the axial position of the needle 22.

The structure of a needle valve is known in principle. Details or components of the needle valve that are covered by a white oval are not of particular relevance to the present invention. This also applies accordingly to other needle valves shown in FIG. 2. There, too, details not relevant to the invention are covered by white ovals.

As can also be seen from FIG. 2, a first additional injection valve 33, which comprises a needle valve 34 and a gear pump (not shown in FIG. 2) opens into the main pipe 31. The first additional injection valve 33 is also shown schematically in FIG. 1. The gear pump is provided with reference sign 35 in FIG. 1.

The first additional injection valve 33 or the needle valve 34 of the additional injection valve 33 has an outlet nozzle 36 with a nozzle tip 37. The outlet nozzle 36 of the additional injection valve 33 protrudes into the main pipe 31. The first additional injection valve 33 can thus be used to introduce the first additive 6 (see FIG. 1) into the main pipe 31. The pressure with which the first additive 6 is introduced into the flow of the A component is of such a size that the first additive 6 is enveloped by the flow of the A component and is carried along therewith without intense mixing of the A component 3 and the first additive 6 occurring.

Without being bound to this theory, a separating boundary layer forms between the A component 3 and the injected additive 6, which prevents the first additive 6 from coming into contact with the inner wall of the vertical main pipe 31. In order for the A component 3 to be able to perform the enveloping function described above, it is provided according to the invention that the nozzle tip 37 of the outlet nozzle 36 is located in a central region of the flow cross section of the main pipe 31. Then the first additive 6 can be completely enclosed within the main pipe. If the outlet nozzle 36 were to end directly at the inner wall of the main pipe, there would be a risk that the first additive 6 would wet the inner wall and adhere thereto.

A center axis 38 of the needle valve 34, which is intended to represent the center axis of the first additional injection valve 33, is perpendicular to the center axis 32 of the main pipe. A needle 39 is arranged to be movable along the center axis 38, by means of which the flow through the needle valve 34 can be adjusted.

In addition to the first additional injection valve 33, FIG. 2 shows a second additional injection valve 40 and a third additional injection valve 41, which have a similar construction to the first additional injection valve 33. Due to the identical structure, features or components of the additional injection valves 40, 41 that are identical to the features or components of the first additional injection valve 33 are provided with the same reference signs. In particular, these additional injection valves 40, 41 each also have an outlet nozzle 36 with a nozzle tip 37. Both the outlet nozzle 36 of the second additional injection valve 40 and the outlet nozzle 36 of the third additional injection valve 41 protrude into the main pipe 31. The second additional injection valve 40 serves to introduce the second additive 7 (see also FIG. 1) into the stream of the A component 3. The third additive 8 can be injected into the main pipe 31 through the third additional injection valve 41.

While the center axis 38 of the first additional injection valve 33 and the center axis 38 of the third additional injection valve 41 are located in the drawing plane, the second additional injection valve 40 is inclined to the drawing plane.

FIG. 3 is a schematic view of a cut-out of the main pipe 31 and the additional injection valves 33, 40 and 41. The outlet nozzle 36 of the first additional injection valve 33 is straight and extends along the center axis 38 of the first additional injection valve 33. It can be seen that the nozzle tip 37 is located in the immediate vicinity of the center axis 32 of the main pipe 31.

FIG. 4, which shows a section along the line IV-IV in FIG. 3, shows the circular flow cross section of the main pipe 31. The flow cross section is defined by a radius R, which can be understood as a connecting line between a cross section center and an inner wall of the main pipe 31. The cross section center is located on the center axis 32. The nozzle tip 37 is located in the central region, which is limited by the dashed circle 42 having a radius Rₘ. According to the invention, the Rₘ/R relationship=0.9. According to the invention, points lying outside the circle 42 do not belong to the central region. In one embodiment, the Rₘ/R relationship is only 0.5, which corresponds approximately to the relationships in FIG. 4.

Compared to the first additional injection valve 33, the second additional injection valve 40 has a modified outlet nozzle 43. The nozzle tip of this modified outlet nozzle 43 is denoted by 44 and, in the same way as the nozzle tip 37 of the first additional injection valve 33, is located in the central region of the flow cross section of the main pipe 31. The outlet nozzle 43 has a 90° angle so that the second additive 7, which is introduced into the main pipe 31 through the second additional injection valve 40, passes through the nozzle tip 44 in the flow direction of the main pipe 31. The third additional injection valve 41 has an outlet nozzle 45 inclined relative to the center axis 38. The angle of inclination between the outlet nozzle 45 and the center axis 38 is denoted by α in FIG. 3 and is approximately 40° to 50° in the embodiment illustrated. Here, too, a nozzle tip 46 of the inclined outlet nozzle 45 is located in the central region of the flow cross section of the main pipe 31.

FIG. 5 shows different cross sections of the outlet nozzle 36 of the first additional injection valve 33. The cross section of the outlet nozzle 36 corresponds to the section along the line V-V in FIG. 3. FIG. 5A shows a round cross section of the outlet nozzle 36. FIG. 5B shows a rectangular cross section of the outlet nozzle 36. The cross section of the outlet nozzle 37 can be optimized to achieve a small flow resistance caused by the outlet nozzle 36 protruding into the main pipe 31, for example by an oval cross section of the outlet nozzle 36 (see FIG. 5C) or by a teardrop shape.

FIGS. 3 to 5 show different embodiments for the outlet nozzle of the additional injection valves 33, 40, 41. It goes without saying that, for example all additional injection valves 33, 40, 41 can have the structure shown by way of example for the first additional injection valve 33 in FIG. 3. In addition, all additional injection valves 30, 40, 41 or a subgroup thereof may have an angled outlet nozzle 43 or an inclined outlet nozzle 45.

FIGS. 1 and 2 are intended to be used to describe a so-called color change in the device 1. It is assumed that, with a constant flow of the A component through the main pipe 31, the first additional injection valve 33 injects the first additive (dye) 6 into the main pipe 31. The A component 3 envelops the first additive 6 exiting the outlet nozzle 36. The A component together with the first additive 6 also flows through the A metering valve 17. In the mixing chamber 70, the A component 3 is mixed with the first dye 6 and the B component 4. A plastics 2 is metered out, which is colored by means of the first dye 6.

After metering out the plastics 2 colored by means of the first dye 6, a plastics 2 colored by means of the second additive (dye) 7 is now to be metered out. For this purpose, the first additional injection valve 33 is closed or alternatively operated in such a way that the gear pump 35 runs backward and draws the dye 6 and/or a small part of the A component that has already been metered out immediately beforehand back into the needle valve 34. After closing or operating the first additional injection valve 33 in reverse, the second additional injection valve 40 is opened so that the second dye 7 is now introduced into the stream of the A component 3. Due to the arrangement of the nozzle tip 37 according to the invention, there are no regions in the main pipe 31 or in the valve chamber 25 of the A metering valve 17 in which the previously metered-out first dye 6 accumulates or deposits. In particular when the nozzle tip 37 is located in the half of the central region facing the outlet 24 of the A metering valve 17 (in the illustration of FIG. 2, this is the half of the central region to the left of the center axis 32), there are practically no significant color residues at the lower end 26 of the valve chamber 25 that would make a color change difficult or delay it. After a comparatively short time after the second dye 7 begins to be metered out, the plastics 2 shows no streaks or contamination caused by the color residues of the first dye 6. Thus, the device 1 according to the invention allows a color change between different dyes 6, 7, 8 to be realized without great effort. The time period during which the plastics 2 shows contamination due to the color change can thus be kept short. This also keeps the effort required for rinsing during a color change to a minimum.

### LIST OF REFERENCE SIGNS

1 device
2 plastics
3 A component
4 B component
5 air
6 first additive/first dye
7 second additive/second dye
8 third additive/third dye
10 A source/pressure vessel 11 pre-circulation pump 12 pressure control valve 13 A metering pump 14 first additional source
15 second additional source
16 third additional source
17 A metering valve
18 B source
19 B metering pump
20 B metering valve
21 side inlet
22 needle
23 center axis
24 outlet
25 valve chamber
26 lower end
27 center axis
30 additional valve unit
31 main pipe
32 center axis
33 first additional injection valve
34 needle valve
35 gear pump
36 outlet nozzle
37 nozzle tip
38 center axis
39 needle
40 second additional injection valve
41 third additional injection valve
42 circle
43 outlet nozzle
44 nozzle tip
45 outlet nozzle
46 nozzle tip
70 mixing chamber
71 A inlet
72 B inlet

1. A device (1) for providing a plastics (2) which is formed from an A component (3) and a B component (4) and optionally from a first additive (6), the device (1) comprising:
a mixing chamber (70) in which the A component (3) and the B component (4) are mixed to form the plastics (2) and from which the plastics (2) can be metered out,.
an additional valve unit (30), which is fluidically arranged upstream of an A inlet (71) of the mixing chamber (70) for the A component (3),
characterized in that the additional valve unit (30) has a main pipe (31) for feeding the A component (3) to the A inlet (71) and a first additional injection valve (33) for feeding the first additive (6) into the main pipe (31), the first additional injection valve (33) having an outlet nozzle (36) opening into the main pipe (31), a nozzle tip (37) of the outlet nozzle (36) lying in a central region of the flow cross section of the main pipe (31), the points of the flow cross section that lie on an inner portion of a radial connecting line between a cross section center point and an inner wall of the main pipe (31) falling in the central region, a length of the inner portion being 90% of the radial connecting line.

2. The device (1) according to claim 1, characterized in that the flow cross section of the main pipe (31) is circular, the radial connecting line corresponding to a radius (R) of the circle.

3. The device (1) according to either claim 1, characterized in that the main pipe (31) extends substantially vertically.

4. The device (1) according to claim 1, characterized in that a center axis (38) of the first additional injection valve (33) is arranged substantially perpendicularly to a center axis (32) of the main pipe (31).

5. The device (1) according to claim 1, characterized in that at least a second additional injection valve (40) is provided for feeding a second additive, the second additional injection valve (40) having an outlet nozzle (36) opening into the main pipe (31), the nozzle tip (37) of which lies in the central region of the flow cross section of the main pipe (31).

6. The device (1) according to claim 5, characterized in that the first additional injection valve (33) and the second additional injection valve (40) are arranged one behind the other in the longitudinal extent of the main pipe (31).

7. The device (1) according to claim 5, characterized in that the center axis (38) of the first additional injection valve (33) is arranged offset from a center axis (38) of the second additional injection valve (40) when viewed in the circumferential direction of the main pipe (31).

8. The device (1) according to claim 1, characterized in that an A metering valve is provided, the main pipe (31) extending substantially perpendicularly to a center axis (23) of the A metering valve (17), and the A component (3) entering the A metering valve (17) through a side inlet (21).

9. The device (1) according to claim 8, characterized in that the A metering valve (17) has an outlet (24), the nozzle tip (37) of the first additional injection valve (33) lying between the cross section center and an outlet-side longitudinal half of the main pipe (31).

10. The device (1) according to claim 1, characterized in that a cross section of the outlet nozzle (36) of the first additional injection valve (33) is circular, oval or teardrop-shaped.

11. The device (1) according to claim 1, characterized in that the outlet nozzle (36) of the first additional injection valve (33) has an angle of approximately 90° and the nozzle tip (37) points in the longitudinal direction of the main pipe (31).

12. The device (1) according to claim 1, characterized in that an angle of inclination of between 20 and 70° is provided between the outlet nozzle (36) and a center axis (38) of the first additional injection valve (33).

13. A method for metering out a plastics (2) with the device (1) according to claim 1, characterized in that the first additional injection valve (33) is controlled after the metering-out process has taken place so that a small portion of the A component (3) is drawn into the outlet nozzle (36) of the first additional injection valve (33).

14. The method according to claim 13 using the device (1), characterized in that the first additional injection valve (33) is arranged upstream of the second additional injection valve (40) when viewed in the flow direction of the main pipe (31), the first additive (6) being formed as a first dye (6) and being lighter than the second additive (7), which is formed as a second dye (7).

15. The method according to claim 14, characterized in that between metering out through the first additional injection valve (33) and metering out through the second additional injection valve (40), the following steps are initiated for the purpose of rinsing:
metering out through the first additional injection valve (33) is stopped, the A component (3) continuing to flow;
the first additional injection valve (40) is controlled in such a way that it draws back some of the first additive (6) and then closes;
metering out through the second additional injection valve (40) is started and continued until the concentration of the first additive (6) in the A metering valve (17) is substantially zero;
the mixing chamber (70) is rinsed with cleaning agent; and
after rinsing, metering out of the second additive (7) is started again.
